(19) United States
(12) Patent Application Publication
(10) Pub. No.: US 2004/0124213 A1
(43) Pub. Date: Jul. 1, 2004

(54) Dispenser for administration of a pharmaceutical fluid

(76) Inventors: Johannis Gillissen, Oss (NL); Cornelis P.M. Govers, Berghem (NL)

Correspondence Address: ST. ONGE STEWARD JOHNSTON & REENS, LLC, 986 BEDFORD STREET, STAMFORD, CT, 06905-5619, US

(21) Appl. No.: 10/736,419

(22) Filed: Dec. 15, 2003

Related U.S. Application Data
(63) Continuation of application No. PCT/EP02/06192, filed on Jun. 5, 2002.

(30) Foreign Application Priority Data
Jun. 15, 2001 (EP) 01202277.8

(51) Int. Cl. G01F 11/06

(52) U.S. Cl. 222/321.6

(57) ABSTRACT

The invention pertains to a dispenser suitable for nasal administration of a pharmaceutical fluid through manual actuation, at least comprising a main body, which includes two extending grips, and an actuator mounted movable relative to the main body and having an actuation surface which is sufficiently wide to support an average human thumb. At least the greater part of the top surface of each of the grips is concave. The dispenser according to the present invention is especially suitable for patients suffering from a disease, such as rheumatoid arthritis, affecting the hands.

This application is a continuation of pending International Patent Application No. PCT/EP02/06192 filed Jun. 5, 2002 which designates the United States and claims priority of pending European Application No. 01202277.8 filed Jun. 15, 2001.

### FIELD OF THE INVENTION

The invention relates to a dispenser for administration of a pharmaceutical fluid, e.g. a solution, suspension, or emulsion of a pharmaceutical substance in a liquid such as water, through manual actuation. The dispenser at least comprises a main body, which includes two extending grips, and an actuator mounted movable relative to the main body and having a actuation surface which is sufficiently wide to support an average human thumb.

Such a dispenser is known from EP-A-0 597 023, which discloses a container/dispenser for endonasal atomised administration. It comprises a main body or slider (numeral 1 in the drawings of EP-A-0 597 023) provided with radially extending faces serving as grips for finger actuation and with an upwardly protruding tubular cylinder supporting the atomising nozzle. The lower part of the slider (1) protrudes downwards forming a cylindrical neck (2) which accommodates an axially slidable cup-shaped button element (3) for operating an internal pump. The pump comprises at least one resilient “detent ring” (8) which is positioned in a groove (6). By means of this configuration, energy is accumulated in the user's hand and instantly released when the resilient detent ring (8) snaps out of the groove (6). Instant release in turn is said to produce the best atomisation not depending on the speed of depression exerted by the user on the slider (1) and the button (3).

Although the dispenser according to EP-A-0 597 023 provides certain advantages, its use by patients suffering from e.g. rheumatoid arthritis, which involves, depending on the stage of the disease, inflammation, swelling, pain, and/or loss of functionality, generally inflicts pain or causes considerable discomfort. Many patients, especially patients in an advanced stage of rheumatoid arthritis, are even effectively unable to use such a dispenser and hence become dependent on other people for the administration of (vital) medicaments. Dependency of this nature does not only imply a health risk but often also diminishes the sense of wellbeing of the patient.

It is an object of the present invention to provide a dispenser that can be used by many patients suffering from various conditions causing sensitive and/or deformed hands, in particular rheumatoid arthritis.

To this end, the dispenser according the present invention is characterised in that at least the greater part of the top surface of each of the grips is concave.

The combination of an actuation surface which is sufficiently wide to support at least an average human thumb, i.e. having a width of at least 2 cm, on the one hand and the concave top surfaces of the grips on the other, appeared to significantly facilitate handling and actuation of the dispenser and reduce or even obviate pain. The radius of curvature of the top surfaces is preferably in a range from 25 to 40 mm.

It is also preferred that the actuation surface is sufficiently wide to support two average human thumbs. By using a wider surface, the number of ways in which the dispenser can be gripped is increased to include an improved palm grip and several two hand grips. Further, the upright position of the dispenser, e.g. when placed on a table, becomes more stable. In this respect, it is also preferred that the centre of gravity is located in the (upper half of the) lower half of the dispenser.

To further reduce pressure on the hands of a user, it is preferred that the radius of curvature of the edge along the actuation surface of the dispenser and/or of the edge along the grips is in excess of 3 mm.

The invention further pertains to a dispenser for administration of a pharmaceutical fluid through manual actuation, wherein the main body and the actuator have a shape as illustrated in FIGS. 1-4 of the drawings.

### BRIEF DESCRIPTION OF DRAWINGS

The invention will now be explained in more detail with reference to the drawings in which a preferred embodiment of the present invention is shown in detail.

FIG. 1 shows a front view of a preferred dispenser for nasal administration according to the present invention.

FIGS. 2 to 4 show respectively a top, side, and bottom view of the dispenser of FIG. 1.

### DETAILED DESCRIPTION OF DRAWINGS

The figures are drawn to scale. Within the framework of this invention, the terms “up”, “upper”, and “top” denote parts or aspects of the dispenser which, upon administration of a pharmaceutical fluid, are relatively close the face of a user. The terms “low”, “lower”, and “bottom” denote parts or aspects relatively distant from the said face.

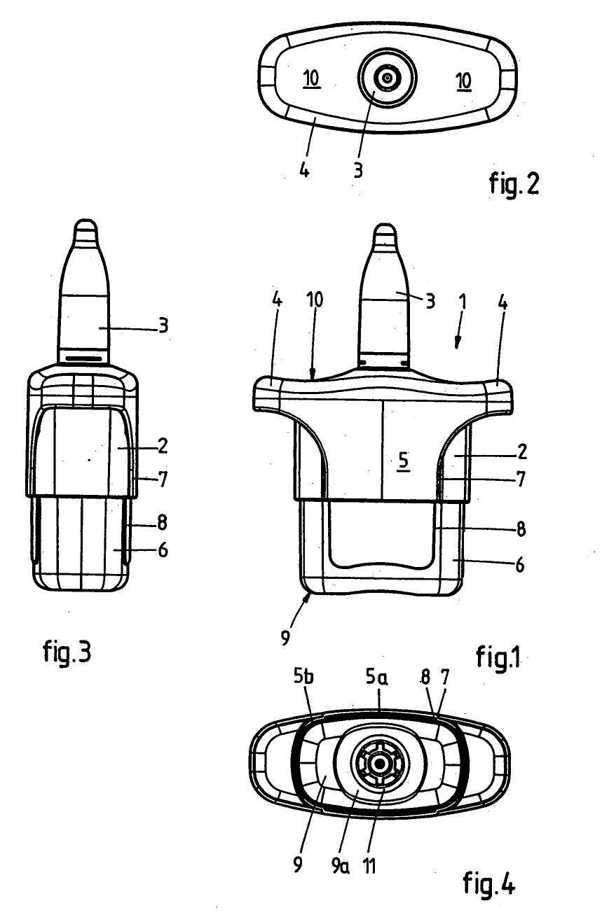

FIGS. 1-4 show a symmetrical dispenser 1 for nasal administration of a pharmaceutical fluid comprising an upper part or main body 2, which supports an elongated nozzle 3 located on the axis of symmetry of the dispenser 1 and comprises two radially extending grips, i.c. shoulders 4. The nozzle 3 may either be a separate part mounted in or on the main body 2 or form an integral whole with the same. Because the grips 4 extend from the main body 2, sufficient room is provided beneath the grips 4 for accommodating one or more fingers that are not employed during actuation.

The lower section of the main body 2 comprises a relatively thin outer wall 5 of substantially oblong cross-section, e.g. oval or, in this particular embodiment, rectangular with slightly convex wall sections 5a joined together by rounded corners 5b having a radius of curvature (hereinafter referred to as “radius”) of at least 4 mm, e.g. 6 mm.

A cup-shaped actuator 6 is mounted in the lower section of main body 2 and can slide in an axial direction relative to the same. The outer dimensions of the upper section of the actuator 6 are equal to or slightly smaller than the inner dimensions of the lower section of the main body 2, thus providing secure guidance of the actuator 6 in the main body 2 and preventing the tilting of the actuator 6, e.g. when it is subjected to an eccentric force. Guidance of the actuator 6 is further improved by means of four longitudinal ribs 7, 8 in the main body 2 and the actuator 6. Further, the bottom surface 9 of the actuator 6 is provided with a shallow concave recess 9a for accommodating an average human thumb. In this particular example, the main body 2, the nozzle 3, and the actuator 6 are manufactured by injection-moulding a polyolefin, such as polyethylene or polypropylene.

The top surfaces 10 of the shoulders 4 are concave, with the radius of curvature preferably in a range from 25 to 40 mm, e.g. 30 mm, and preferably at least 15 mm wide, thus providing a secure and comfortable grip. Optionally, friction can be improved by increasing the roughness of the surfaces 10, by providing a pattern of protrusions e.g. dots or lines, and/or by applying a coating or layer of a material having a high coefficient of friction to the surfaces 10. To facilitate handling and actuation further still, it is preferred that the distance between the top surfaces 10 and the bottom surface 9a of the actuator 6 is in a range from 40 to 60 mm, preferably from 50 to 55 mm.

Depending on the nature and stage of a disease and/or on preference, the user of the dispenser 1 can select one of many ways of holding and actuating the dispenser according to the present invention. A preferred example is the so-called pinch grip, where the user places the forefinger and the middle finger on respective shoulders and places the thumb on the bottom surface of the actuator. In that case, the ring and little finger are automatically positioned beneath one of the shoulders thus avoiding needless strain on the joints of those fingers. Further suitable examples are the palm grip, which differs from the pinch grip in that the palm of the hand instead of the thumb is placed on the bottom surface of the actuator, and the two hand grip, where the user places both fore or middle fingers, one on each shoulder, and both thumbs on the bottom surface of the actuator, i.e. uses both hands simultaneously.

The internals of the dispenser according to the present invention may be configured in numerous ways. Suitable examples are shown and described in EP-A-0 597 023 discusses above and in EP-A-0 546 607. The person skilled in the art is will have no difficulty in selecting or designing a suitable mechanism to meet the requirements of a specific (use of a) dispenser.

It this respect, it is noted that it is preferred to employ a mechanism which subdivides the fluid contained in the dispenser into two (sub) administrations, one for each nostril. It is further preferred that the distance between the top surfaces of the shoulders and the bottom surface of the actuator is at least substantially equal at the onset of each (sub)administration and/or that no complicated movements for switching to the next (sub)administration are required.

Means for instantly releasing the energy accumulated in the user's hand, so as to generate a spray having reproducible average particle size (in a range from 10 to 150 μm, preferably from 30 to 100 μm) and particle size distribution, are preferably also provided. Since many patients have limited strength, the force needed for actuation should preferably be less than 50 N. Moreover, a low force will result in less pressure (N/cm²) on the fingers, thumb, or palm of the user.

To facilitate insertion of a sterile glass vial in the dispenser 1, the bottom of the actuator 6 is provided with an opening 11, which is in line with an internal chamber for receiving the vial. Such a vial can contain an amount, e.g. 200 μl, of the pharmaceutical fluid sufficient for two (sub) administrations of 100 μl, one in each nostril.

It appeared that the dispenser according to the present invention could be actuated effectively by patients suffering from rheumatoid arthritis and that it caused significantly less or even no pain or discomfort.

The invention is not restricted to the above described embodiments which can be varied in a number of ways within the scope of the claims. The dispenser could, for instance, be manufactured from a biodegradable plastic.

What is claimed is:

1. Dispenser (1) for administration of a pharmaceutical fluid through manual actuation, at least comprising a main body (2), which includes two extending grips (4), and an actuator (6) mounted movable relative to the main body (2) and having an actuation surface (9) which is sufficiently wide to support an average human thumb, characterised in that at least the greater part of the top surface (10) of each of the grips (4) is concave.

2. Dispenser (1) according to claim 1, wherein the actuation surface (9) is sufficiently wide to support two average human thumbs.

3. Dispenser (1) according to claim 1 or 2, wherein the radius of curvature of the edge along the actuation surface (9) and/or of the top edge along the grips (4) is in excess of 3 mm.

4. Dispenser (1) according to any one of the preceding claims, wherein the actuation surface (9) is provided with a shallow recess (9a) for accommodating an average human thumb.

5. Dispenser (1) according to any one of the preceding claims, wherein the cross-section of the actuator (6) and of that part of the main body (2) in which the actuator (6) is mounted is oblong.

6. Dispenser (1) according to any one of the preceding claims, wherein the actuator (6) and the main body (2) are provided with co-operating guiding features (7,8) extending in the direction of actuation.

7. Dispenser (1) according to any one of the preceding claims, wherein the actuation force is less than 50 N.

8. Dispenser (1) according to any one of the preceding claims, wherein the center of gravity is located in the lower half of the dispenser (1).

9. Dispenser (1) for administration of a pharmaceutical fluid through manual actuation, at least comprising a main body (2), which includes two extending grips (4), and an actuator (6) mounted movable relative to the main body (2) and having an actuation surface (9) which is sufficiently wide to support an average human thumb, characterised in that the main body (2) and the actuator (6) have a shape as illustrated in FIGS. 1-4 of the drawings.

10. Dispenser (1) according to any one of the preceding claims, which contains a pharmaceutical fluid preferably for treating rheumatoid arthritis.
